(19) United States
(12) Patent Application Publication
(10) Pub. No.: US 2008/0092310 A1
(43) Pub. Date: Apr. 24, 2008

(54) DYE MATERIAL, DYE SOLUTION AND MULTIPHOTON ABSORPTION REACTION MATERIAL USING THE SAME, REACTION PRODUCT, MULTIPHOTON ABSORPTION REACTION MATERIAL, GOLD NANORODS AND MANUFACTURING METHOD OF GOLD NANORODS

(76) Inventors: Takeshi Miki, Tokyo (JP); Shigeyoshi Misawa, Tokyo (JP); Tsutomu Sato, Yokohama-shi (JP); Tatsuya Tomura, Tokyo (JP); Mikiko Takada, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/926,620

(22) Filed: Oct. 29, 2007

Related U.S. Application Data
(63) Continuation of application No. PCT/JP06/09188, filed on Apr. 26, 2006.

(30) Foreign Application Priority Data
Apr. 27, 2005 (JP) 2005-129342
Feb. 16, 2006 (JP) 2006-039143

(51) Int. Cl. C09B 67/02

(52) U.S. Cl. 8/524

(57) ABSTRACT

To provide a dye material containing fine particles and a multiphoton absorbent material, wherein the fine particles are fine metal particles that generate enhanced surface plasmon field or fine particles partially coated with a metal that generates enhanced surface plasmon field. Also provided is a multiphoton absorbent material which can obtain the irradiation effect more intense than the irradiation light using the dye material.

### CROSS-REFERENCE TO RELATED APPLICATION

This is a continuation of Application No. PCT/JP2006/309188, filed on Apr. 26, 2006.

### BACKGROUND OF THE INVENTION

1. Field of the Invention

The present invention relates to dye material, dye solution and multiphoton absorption reaction material using dye material and dye solution, reaction product, multiphoton absorption reaction material, gold nanorods and manufacturing method of gold nanorods.

2. Description of the Related Art

It is known that when one of the multiphoton absorption processes, two-photon absorption reaction is utilized, it is possible to initiate reaction only in the focusing point by using focused beams because the reaction is induced by absorption corresponding to a square of excitation light intensity, which is a characteristic of the two-photon absorption reaction.

In other words, since it is possible to initiate reaction at a random desired spot and further, it is possible to initiate photo-reaction only in part where the light intensity is high, which is the center part of the focusing spot, expectations for the process recording which surpass the diffraction limit has been raised.

However, because of the extremely small absorbing sectional area of the multiphoton absorption reaction as represented by two-photon absorption reaction, there is a problem of indispensable requisites such that the excitation is induced by expensive and large pulsed laser source with a notably high peak power such as femtosecond lasers.

Therefore, it is very necessary to develop a multiphoton absorbent material with a high sensitivity, which does not require large pulsed lasers and capable of inducing reactions through laser diode, for example, in order to accelerate diffusion of applications, which makes full use of excellent characteristics of the multiphoton absorption reaction.

At the same time, as a sensitizing method of one-photon absorption processes based on optical principle, a method in which optical evaluation and measurement on the material of extremely small amount are conducted by using enhanced surface plasmon field being excited on the surface of a metal, is known.

When a surface plasmon microscope is applied, for example, a technique in which an ultrathin film (the enhanced surface plasmon field is generated within a limited region, approximately 100 nm or less from the surface), which is disposed on the thin metal film formed on the high-refractive index medium, is used as a sample has been proposed (see Japanese Patent Application Laid-Open (JP-A) No. 2004-156911).

Furthermore, a measuring technique using enhanced surface plasmon field, which is excited by metal fine particles has been known. In this technique, observed measurement region is limited to the surrounding region of 100 nm or less from the metal fine particles, as similar to the technique disclosed in JP-A No. 2004-156911, and observation with a high sensitivity is conducted by observing the sample absorbed on the surface of the particles.

A technique of tuning resonance wavelength by spherical core-shell structure, as a technique to select the wavelength applicable for observation has also been known (see JP-A No. 2001-513198).

Further, a highly-sensitive observation method containing multiphoton processes using aggregated nanoparticles arranged inside a microcavity is disclosed (see JP-A No. 2004-530867).

In the meantime, a technique using gold nanorods as a means to generate enhanced surface plasmon field, instead of the above metal fine particles is under research in recent years.

The gold nanorods are materials which are characterized by being able to change resonance wavelength by changes in aspect ratio and can cover from approximately 540 nm to infrared (approximately 1,100 nm) region.

An exemplary manufacturing method of gold nanorods, by which the gold nanorods are manufactured by electric chemical reaction in a solution containing surfactants, is disclosed in JP-A No. 2005-68447.

However, the sample of the technique, which is disclosed in JP-A No. 2004-156911, is limited to ultrathin film on the thin metal films regarding to the enhancing effect on a thin film, and the applicable region of surface plasmon enhancing effect depends on the forms of the thin metal films and arrangements of the optical systems and it is difficult to apply in applications such as three-dimensional processes.

Moreover, the technique disclosed in JP-A No. 2001-513198 uses enhanced surface plasmon field generated around the particles such as metal fine particles, and the flexibility, in terms of the configuration of the enhanced field generation, is improved, compared to the technique disclosed in JP-A No. 2004-156911. However, the spots for generating enhanced field are also restricted because highly-sensitive reaction and detection are made possible by particles, which generates enhanced surface plasmon field, being distributed on the object surface by the mutual interaction with the object surface.

The application of enhanced field is also limited for the technique disclosed in JP-A No. 2004-530867, because aggregated nanoparticles, which are means to generate enhanced surface plasmon field, are arranged within a closed nanospace called microcavity.

As regard to the technique disclosed in JP-A No. 2005-68447, flexibility in excitation wavelength selection for the generating means of enhanced surface plasmon field, which is capable of tuning wavelength, is improved; however, a problem still arises in arrangement of excitation sources and reaction materials.

### BRIEF SUMMARY OF THE INVENTION

By the present invention, a composition using enhanced surface plasmon field as a sensitizing method of multiphoton absorption reaction is provided and further, a composition in which enhanced surface plasmon field is usable in plane distributions as concentrated spots and also in three-dimensional random spots is also provided. The object of the present invention is to provide dye material using multiphoton absorbent material, which is usable as a bulk of high sensitivity previously unheard of, dye solution, gold nanorods making up the multiphoton absorbent material and manufacturing method of gold nanorods using the above compositions.

The means to settle above issues are as follow.

<A>. A dye material, including:

fine particles and a multiphoton absorbent material,

wherein the fine particles are fine metal particles that generate enhanced surface plasmon field or fine particles partially coated with a metal that generates enhanced surface plasmon field.

<2A>. The dye material according to <1A>, wherein the dye material is used as a multiphoton absorption reaction auxiliary agent.

<3A>. The dye material according to <1A>, wherein the outermost surface of the fine particles is coated with an insulation layer.

<4A>. The dye material according to <3A>, wherein the dye material is used as a multiphoton absorption reaction auxiliary agent.

<5A>. The dye material according to <1A>, wherein the fine particles have anisotropy.

<6A>. The dye material according to <5A>, wherein the dye material is used as a multiphoton absorption reaction auxiliary agent.

<7A>. The dye material according to <5A>, wherein the outermost surface of the fine particles that have anisotropy is coated with an insulation layer.

<8A>. The dye material according to <8A>, wherein the dye material is used as a multiphoton absorption reaction auxiliary agent.

<9A>. The dye material according to <5A>, wherein the fine particles that have anisotropy are gold nanorods.

<10A>. The dye material according to <9A>, wherein the dye material is used as a multiphoton absorption reaction auxiliary agent.

<11A>. The dye material according to <9A>, wherein the outermost surface of the gold nanorods is coated with an insulation layer.

<12A>. The dye material according to <11A>, wherein the dye material is used as a multiphoton absorption reaction auxiliary agent.

<13A>. A dye material, including:

fine particles and a multiphoton absorbent material,

wherein the fine particles are fine metal particles that have a core-shell structure and generate enhanced surface plasmon field or fine particles that have a core-shell structure and are partially coated with a metal that generates enhanced surface plasmon field.

<14A>. The dye material according to <13A>, wherein the outermost surface of the fine particles is coated with an insulation layer.

<15A>. The dye material according to <13A>, wherein the fine particles have anisotropy.

<16A>. The dye material according to <15A>, wherein the outermost surface of the fine particles is coated with an insulation layer.

<17A>. The dye material according to <15A>, wherein the fine particles that have anisotropy are gold nanorods.

<18A>. The dye material according to <17A>, wherein the outermost surface of the gold nanorods is coated with an insulation layer.

<19A>. The dye material according to <18A>, wherein the dye material is used as a multiphoton absorption reaction auxiliary agent.

<1> A dye material including one of metal fine particles and partially-coated fine particles, and a multiphoton absorbent material, wherein the metal fine particles generate enhanced surface plasmon field and the partially-coated fine particles are partially coated with a metal which generates enhanced surface plasmon field.

<2> The dye material as stated in above <1>, wherein the outermost surface of the fine particles is coated with an insulation layer.

<3> The dye material as stated in above <1> and <2>, wherein the fine particles contain anisotropy.

<4> The dye material as stated in above <1> and <3>, wherein the fine particles are gold nanorods.

<5> A dye solution containing a dye material, and a solvent, wherein the dye material is the dye material as stated in above <1> and <4>.

<6> A multiphoton absorption reaction material containing one of dye material and dye solution, wherein the dye material is the dye material as stated in above <1> and <4>, and the dye solution is the dye solution as stated in above <5>.

<7> A reaction product containing one of dye material and dye solution, wherein the dye material is the dye material as stated in above <1> and <4>, and the dye solution is the dye solution as stated in above <5>

<8> A multiphoton absorption reaction auxiliary agent containing one of dye material and dye solution, wherein the dye material is the dye material as stated in above <1> and <4>, and the dye solution is the dye solution as stated in above <5>.

<9> A manufacturing method of gold nanorods containing reducing of gold nanorods by adding a surfactant to water and oil-based solvent to form a micelle, and producing of the gold nanorods containing a core-shell structure by providing a silane coupling agent in a dispersion state of the gold nanorods.

<10> The manufacturing method of gold nanorods as stated in above <9>, wherein a dye is dispersed near the gold nanorods in the micelle by adding a water-insoluble dye dissolved in an organic solvent in a dispersion state of the gold nanorods.

<11> The manufacturing method of gold nanorods as stated in above <10>, wherein a multilayer structure of the gold nanorods and the dye is formed by evaporating the oil-based solvent from a dispersion liquid of the gold nanorods and depositing the dye on the surface of the gold nanorods.

<12> The manufacturing method of gold nanorods as stated in above <11>, wherein the surface of the multilayer structure of the gold nanorods and the dye is coated with silane coupling agent.

<13> A gold nanorod containing manufacturing method of gold nanorods, wherein the gold nanorod is manufactured by the manufacturing method of gold nanorods, and the manufacturing method of gold nanorods is the manufacturing method of gold nanorods as stated in above <9> and <12>.

<14> A manufacturing method of gold nanorods containing reducing of gold nanorods by adding a surfactant to water and oil-based solvent to form a micelle, and forming of a core-shell structure by providing a silane coupling agent in a dispersion state of the gold nanorods.

<15> The manufacturing method of gold nanorods as stated in above <14>, wherein a multilayer structure of the gold nanorods and the dye is formed by adding a water-insoluble dye dissolved in an organic solvent in a dispersion state of the gold nanorods to disperse the dye near the gold nanorods in the micelle and by evaporating the organic solvent and depositing the dye on the surface of the gold nanorods.

<16> The manufacturing method of gold nanorods as stated in above <14>, wherein the surface of the multilayer structure of the gold nanorods and the dye is further coated with silane coupling agent.

<17> A gold nanorod containing a core-shell structure, wherein the core-shell structure is manufactured by the manufacturing method of gold nanorods as stated in above <14> and <16>.

<18> A multiphoton absorption reaction material containing gold nanorods, wherein the gold nanorods contain the core-shell structure as stated in above <17>.

<19> A reaction product containing gold nanorods, wherein the gold nanorods contain the core-shell structure as stated in above <17>.

<20> A multiphoton absorption reaction auxiliary agent containing gold nanorods, wherein the gold nanorods contain the core-shell structure as stated in above <17>.

### BRIEF DESCRIPTION OF THE SEVERAL VIEWS OF THE DRAWINGS

FIG. 1A is a schematic diagram of a recording/reading system of three-dimensional multilayer optical memory.

FIG. 1B is a cross-sectional schematic diagram showing a three-dimensional recording medium.

FIG. 2 is a schematic diagram showing an apparatus applicable for two-photon optical modeling method.

FIG. 3 is a schematic diagram showing a basic composition of two-photon excitation laser scanning microscope.

FIG. 4 shows a correlation between excitation light intensity and two-photon fluorescence intensity (with gold nanorods coated with SiO₂).

FIG. 5 shows a correlation between excitation light intensity and two-photon fluorescence intensity (with gold nanorods, not coated with SiO₂).

FIG. 6 shows a correlation between excitation light intensity and two-photon fluorescence intensity (with spherical gold fine particles coated with SiO₂).

FIG. 7 shows a correlation between excitation light intensity and two-photon fluorescence intensity (with fine particles, not coated with SiO₂).

FIG. 8 shows an absorption spectrum of a sample solution.

### DESCRIPTION OF THE PREFERRED EMBODIMENTS

### Dye Material and Dye Solution

The dye material of the present invention contains one of metal fine particles which generate enhanced surface plasmon field and fine particles at least partially coated with a metal which generates enhanced surface plasmon field, and multiphoton absorbent material and further contains other elements as necessary.

A multiphoton absorbent material of high sensitivity can be obtained by using above dye material. The dye material may be in form of dye solution combined with a solvent.

An applicable configuration of the multiphoton absorbent material of the present invention will be explained specifically below.
Application for Three-Dimensional Multilayer Optical Memory using Multiphoton Absorbent Material of the Present Invention, in particular, Two-Photon Absorbent material—

In recent years, networks such as internet and high-vision TVs are being rapidly diffused.

The capacity of 50 GB or more is preferable even for consumer use in terms of high definition television (HDTV) and in particular, demands for large-capacity recording media for recording image information of 100 GB or more easily and inexpensively are increasing.

Moreover, optical recording media which are capable of recording a large capacity of information of approximately 1 TB or more at high velocities inexpensively are demanded for industrial use such as computer backups and broadcasting backups.

The capacities of existing two-photon optical recording media such as DVD±R, etc. are approximately 25 GB at most even when the recording and reading wavelength are shortened and it is a common concern that the demand for more large capacity hereafter cannot be satisfied sufficiently.

In the situation described above, a three-dimensional optical recording medium is attracting attention as a high-density, large-capacity recording medium.

A three-dimensional optical recording medium achieves ultra-high density, ultra-large capacity recording, which is tens and hundreds times of that of existing two-dimensional recording media, by performing recording in tens and hundreds of layers in three-dimensional (layer thickness) direction.

It is necessary to be able to access random spots in three-dimensional (layer thickness) direction to write data for providing the above three-dimensional optical recording medium and the means to do that include a method using two-photon absorbent material and a method using holography (interference).

The three-dimensional optical recording medium using two-photon absorbent material is capable of bit recording in tens and hundreds times, based on physical principles and is capable of higher density recording; therefore, it is precisely a supreme high-density, large-capacity optical recording medium.

As regard to the three-dimensional optical recording medium using two-photon absorbent material, a method in which fluorescent materials are used for recording and reading and reading is performed by using fluorescence (JP-A No. 2001-524245 and JP-A No. 2000-512061) and a method in which reading is performed by absorption using photochromic compounds or by using fluorescence (JP-A No. 2001-522119 and JP-A No. 2001-508221) have been proposed.

However, in either proposal for the three-dimensional optical recording media, two-photon absorbent materials are not specified or only described abstractly and also, the examples of two-photon absorption compounds have extremely small efficiency of two-photon absorption.

Moreover, since photochromic compounds used in these techniques are reversible materials which pose practical issues in nondestructive reading, storage property of records in prolonged periods and S/N ratio in reading, these techniques are not of practical use as an optical recording medium.

It is preferable to perform reading by the changes in reflectance (refractive index or absorbance) or emission intensity using reversible materials, particularly in terms of nondestructive reading and storage property of records in prolonged periods, however, there are no examples specifically disclosing the two-photon absorbent materials having above features.

Furthermore, recording apparatuses which perform recording three dimensionally by refractive index modulation, reading apparatuses and reading methods are disclosed in JP-A No. 6-28672 and JP-A No. 6-118306. However, techniques related to methods using two-photon-absorption, three-dimensional optical recording materials are not disclosed in these literatures.

As described above, if a reaction is initiated by using excitation energy obtained from nonresonant two-photon absorption to modulate emission intensities between laser focus point (recording) part and non-focus point (unrecorded) part during light irradiation by a non-rewritable method, it is possible to initiate emission intensity modulation in random spots of three-dimensional space with extremely high spatial resolution, making it applicable for three-dimensional optical recording medium, which is thought to be an ultimate high density recording medium.

Furthermore, since it is an irreversible material and is capable of nondestructive reading; an appropriate storage property can be expected and is practical for use.

However, the two-photon absorption compounds, which have been assumed to be usable, have a disadvantage of taking long recording time because two-photon absorbing power is low and a laser of extremely high power is needed as a beam source. The development of two-photon-absorption three-dimensional optical recording material, which is capable of performing recording with a high sensitivity by the difference in emission powers using two-photon absorption, for achieving speedy transfer rate is necessary particularly for the use in the three-dimensional optical recording medium. For that purpose, a material which contains two-photon absorption compounds which can absorb two-photon highly efficiently to generate excited condition, and recording elements which can make differences in emission powers of two-photon-absorption optical recording material by some kind of method using excited condition of the two-photon absorption compounds, is effective, however, such material has not been disclosed before and the development of this kind of material has been desired.

By the present invention, two-photon absorption optical recording and reading method which performs recording using multiphoton absorbent material, in concrete terms, two-photon absorption of the two-photon absorbent material and reading by detecting the difference in emission intensities after a light is irradiated to the recording material or by detecting the reflectance changes caused by changes in refractive index, and two-photon absorption optical recording material which is capable of such recording and reading are provided.

Moreover, multi(two)photon-absorption three-dimensional optical recording material and multi(two)photon-absorption three-dimensional optical recording and reading method using above materials are provided.

The multi(two)photon absorption optical material may be made into a multi(two)photon absorption optical recording material by applying directly on a substrate using spin coater, roll coater or bar coater or, by casting as a film and laminating on the substrate by usual methods.

The above substrate may be any one of a given natural or synthetic support, and preferably flexible or rigid film, sheet or plate.

The preferred examples include polyethylene terephthalate, resin-subbed polyethylene terephthalate flame or electrostatic discharge treated polyethylene terephthalate, cellulose acetate, polycarbonate, polymethylmethacrylate, polyester, polyvinyl alcohol, glass, and the like.

In addition, substrates on which guide grooves for tracking or address information are provided in advance may also be used.

When a multi(two)photon absorption optical recording material is prepared by using multi(two)photon absorption optical material, the used solvent is removed by evaporation during drying.

The evaporation removal may be performed by any one of heating and depressurizing.

Furthermore, protective layers (intermediate layers) may be formed on the multi(two)photon absorption optical recording material as oxygen block or for prevention of interlayer cross talks.

The protective layers (intermediate layers) may be formed by using polyolefin such as polypropylene and polyethylene, polyvinyl chloride, polyvinylidene chloride, polyvinyl alcohol, polyethylene terephthalate, or plastic films such as cellophane film or, plates may be bonded together using electrostatic adherence or lamination layer using extruder or, solutions of above polymers may be applied.

It is also possible to form protective layers by bonding glass plates together.

Moreover, it is also possible to have adhesives or liquid materials in between protective layer and photosensitive film and/or base material and photosensitive film for improving airtightness.

Further, guide grooves for tracking or address information may be provided on the protective layers (intermediate layers) between photosensitive films in advance.

It functions as the three-dimensional recording medium of the present invention by performing recording and reading while focusing on arbitrary layer of the above-mentioned three-dimensional multilayer optical recording medium. Furthermore, it is capable of performing three-dimensional recording in a depth direction even though boundaries between layers are not marked by protective layers (intermediate layers), because of the characteristic of the multi(two)photon absorption dye.

Herein below, a preferable embodiment of the three-dimensional multilayer optical memory will be described as an example of the three-dimensional recording medium of the present invention.

The present invention is not limited to these embodiments, and may be in any other composition as long as it is capable of performing three-dimensional recording (recording in a flat and layer thickness directions).

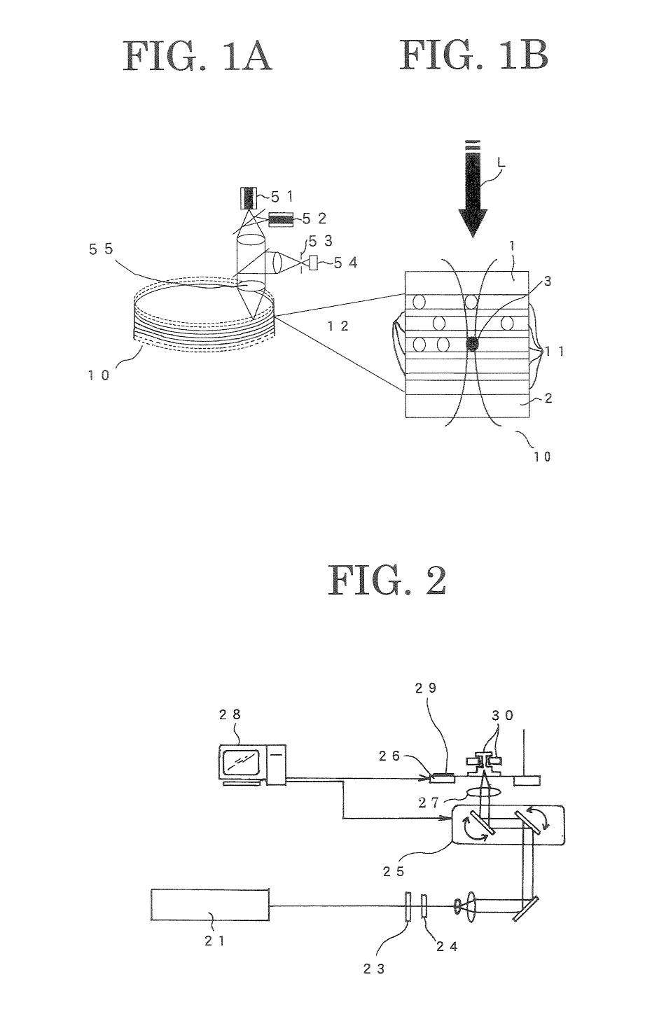

A schematic diagram of recording/reading system of the three-dimensional multilayer optical memory is shown in FIG. 1A and a schematic cross-sectional diagram of the three-dimensional recording medium is shown in FIG. 1B.

The brief overview of the recording method of the system will be explained referring to FIG. 1A.

A recording laser beam, which is emitted from a laser source for recording 51 (a pulsed laser source of high power, for example), is focused on a three-dimensional recording medium 10 through an objective lens 55.

At a focus point, recording is performed by two-photon absorption. However, recording by two-photon absorption is not performed in places other than the focus point due to square effect because irradiation power is low as mentioned above. In other words, a selective recording is possible.

Next, a laser beam emitted from a laser source for reading 52 (it is not as high as the power of the recording beam and a laser diode is also usable) is focused on the three-dimensional medium 10 for reading.

Signal lights generated from each layer are detected by means of a point detector, which is composed of a pinhole 53 and detector 54, and a signal from a specific layer is selectively detected by using a principle of confocal microscope.

The three-dimensional recording/reading can be performed by means of the above apparatus composition and operation.

The three-dimensional recording medium 10 as shown in FIG. 1B has a composition in which 50 layers each of the recording layer 11, which uses multi (two) photon absorption compounds and intermediate layer (protective layer) 12 for preventing crosstalks are provided alternately on a flat support (substrate 1) and each layer is formed by spin coating.

The thickness of the recording layer 11 is preferably 0.01 μm to 0.5 μm and the thickness of the intermediate layer 12 is preferably 0.1 μm to 5 μm.

With the composition as described above, it is possible to perform ultra high-density optical recording at tera-byte level with a disc size as same as known CD and DVD.

Moreover, a substrate 2 (protective layer) as similar to the substrate 1 or a reflective film composed of high-reflectance material is formed on the opposite side with the recording layer 11-mediated, in accordance with the reading method of data (transmissive or reflective type).

A single beam (laser beam L in FIG. 1B) of ultra-short, femtosecond-order pulsed light is used during forming of a recording bit 3.

It is also possible to use light of the different wavelengths other than the beam used for data recording or light of the same wavelength with low output power.

Recording and reading can be performed either by bits or by pages and parallel recording/reading, which uses surface light sources or two-dimensional detectors, are effective in speeding up of transfer rates.

Meanwhile, the embodiments of the three-dimensional multilayer optical memory, which is formed similarly in accordance with the present invention, include card-like, plate-like, tape-like and drum-like configurations.
Application for Two-Photon Optical Modeling Material in which Two-Photon Absorbent Material is used as Multiphoton Absorbent Material—

The schematic diagram of an apparatus to which a two-photon optical modeling method, a method which uses a two-photon absorbent material, is applied is shown in FIG. 2.

The apparatus of FIG. 2 is equipped with near-infrared pulsed beam source 21, shutter 23, ND filter 24, mirror scanner 25, Z stage 26, lens 27, computer 28, optically-curable resin liquid 29 and optically modeled object 30.

The two-photon micro-optical modeling method, a method which is used to form an arbitrary three-dimensional composition is performed by scanning a laser spot focused on the optically-curable resin 29 using a lens after a laser beam, which is generated from the near-infrared pulsed beam source 21, is passed through the mirror scanner 25, and by curing the resin in only near the focusing point by inducing a two-photon absorption.

A pulsed laser beam is focused by a lens to form a region with high photon density near the focusing point. At this time, the total number of photons, which pass through each cross-section surface of the beam, is constant; therefore, the summation of the light intensity at each cross-section surface is also constant when a beam is scanned two-dimensionally in focal plane.

However, because the probability of two-photon absorption is proportional to a square of the light intensity, a region with a high probability of two-photon absorption is formed only near the focusing point with a high light intensity.

By focusing the pulsed laser beam by a lens to induce two-photon absorption as described above, it becomes possible to limit the optical absorption near the focusing point for curing the resin pinpointingly.

Since the focusing point can be moved freely in the optically-curable resin liquid 29 by means of a Z stage 26 and a galvanometer mirror, it is possible to form a desired three-dimensional product freely in the optically-curable resin is liquid 29.

The two-photon optical-modeling method has the following characteristics.

(a) Resolution which surpasses the diffraction limit: A resolution which surpasses the optical diffraction limit can be realized by nonlinearity against light intensity of the two-photon absorption.

(b) Ultra high-speed modeling: When the two-photon absorption is used, the optically-curable resin is not cured in the region other than the focusing point in principle. Therefore, it is possible to speed up the scanning velocity of the beam by increasing the light intensity of irradiation. Therefore, the modeling velocity can be increased to approximately ten times as much.

(c) Three-dimensional process: The optically-curable resin is transparent to the near-infrared light which induces the two-photon absorption. Therefore, internal curing is possible even when a focused beam is focused deeply into the resin. The problem associated with existing SIH, a difficulty in internal curing due to the decreased light intensity of the focusing point caused by light absorption when a beam is focused deeply, can be settled with certainty according to the present invention.

(d) High yield: There are problems of modeling product being broken or deformed by viscosity or surface tension of the resin with existing methods, however, such problems can be settled because modeling is performed inside the resin according to the present invention.

(e) Application for mass production: It is possible to manufacture a large number of parts or movable bodies serially in a short period of time by using ultra high-speed modeling.

The optically-curable resin 29 for two-photon optical modeling has a characteristic of initiating a two-photon polymerization reaction through light irradiation and altering itself from liquid to solid state.

The main constituents are a resin component composed of an oligomer and reactive diluent and a photo polymerization initiator (includes a photosensitizing material as necessary).

The oligomer is a polymer with a polymerization degree of approximately 2 to 20, which has many terminal reactive groups.

Moreover, a reactive diluent is added in order to adjust viscosity and curing property.

When a laser beam is irradiated, the polymerization initiator or photosensitizing material performs two-photon absorption to generate reactive species directly from the polymerization initiator or through the photosensitizing material and the polymerization is initialized by the reaction with reactive groups of oligomer and reactive diluent.

And then, chained polymerization reaction between these reactive groups takes place to form a three-dimensional cross-linkage and it becomes a solid resin having a three-dimensional network in a short period of time.

The optically-curable resin is used in fields such as optically-curable ink, optical adhesion bond and laminated three-dimensional modeling and resins with various properties have been developed.

Particularly for the laminated three-dimensional modeling, (1) appropriate reactivity, (2) less volume reduction during curing and (3) excellent mechanical properties after curing are important.

These properties are also important for the present invention and therefore, the resin, which is developed for laminated three-dimensional modeling and has a property of two-photon absorption, can be also used as the optically-curable resin for two-photon optical modeling of the present invention.

The specific examples, which are being used often, include acrylate-based and epoxy-based optically-curable resins and urethane acrylate-based optically-curable resins are particularly preferable.

A technique related to optical modeling known in the art is disclosed in JP-A No. 2005-134873.

This is a technique in which an interference exposure of the surface of photo-sensitive polymer film is performed by means of a pulsed laser beam without a mask.

It is important to use a pulsed laser beam of a wavelength region, in which photo-sensitive feature of the photo-sensitive polymer films can be brought out.

Thereby, it is possible to appropriately select the wavelength region of the pulsed laser beam corresponding to the types of photo-sensitive polymers or groups or types of regions by which photo-sensitive feature of the photo-sensitive polymers is brought out.

In particular, it is possible to bring out the photo-sensitive feature of the photo-sensitive polymer films by going through a multilayer absorption process at the time of irradiating pulsed laser beams, even when the wavelength of the pulsed laser beams emitted from the light source does not fall within the wavelength region, in which the photo-sensitive feature of the photo-sensitive polymer films can be brought out.

Specifically, if a focused pulsed laser beam is irradiated from a light source, absorption of multiphoton (absorption of two-photon, three-photon, four-photon, five-photon, etc., for example) takes place and the photo-sensitive polymer films practically receive the pulsed laser beam of a wavelength region where a photo-sensitive feature of the photo-sensitive polymer films is brought out, even though the wavelength of the pulsed laser beam irradiated from the light source may not fall within a wavelength region where the photo-sensitive feature of the photo-sensitive polymer films can be brought out.

As described above, the pulsed laser beam for interference exposure may be a pulsed laser beam of the wavelength region where a photo-sensitive feature of the photo-sensitive polymer films can practically be brought out and the wavelength may be appropriately selected depending on irradiation condition.

For example, it becomes possible to obtain an ultraprecise three-dimensional modeling product by having a photosensitizing material as a two-photon absorbent material of the present invention, dispersing the material in an ultraviolet curable resin to produce a photosensitive solid substance and using a property of curing only in a focusing spot by using two-photon absorbing power of the photosensitive solid substance.

The two-photon absorbent material of the present invention may be used as a two-photon absorption polymerization initiator or a two-photon absorption photosensitizing material.

Since the two-photon absorbent material of the present invention has high two-photon absorption sensitivity compared to that of the two-photon absorbent materials (two-photon absorption polymerization initiator or two-photon absorption photosensitizing material) in related art, it is capable of high-speed modeling and can utilize a small sized and inexpensive laser beam source as an excitation light source, making it applicable for practical use capable of mass production.
Application for Two-Photon Fluorescence Microscope Using Multi(Two)Photon Absorbent Material—

A multi(two)photon excitation laser scanning microscope is a microscope that focus and scan the near-infrared pulsed laser on the surface of a sample to detect the fluorescence generated by an excitation induced by multi(two)photon absorption to obtain an image. A specific example of the two-photon excitation laser scanning microscope will be explained below.

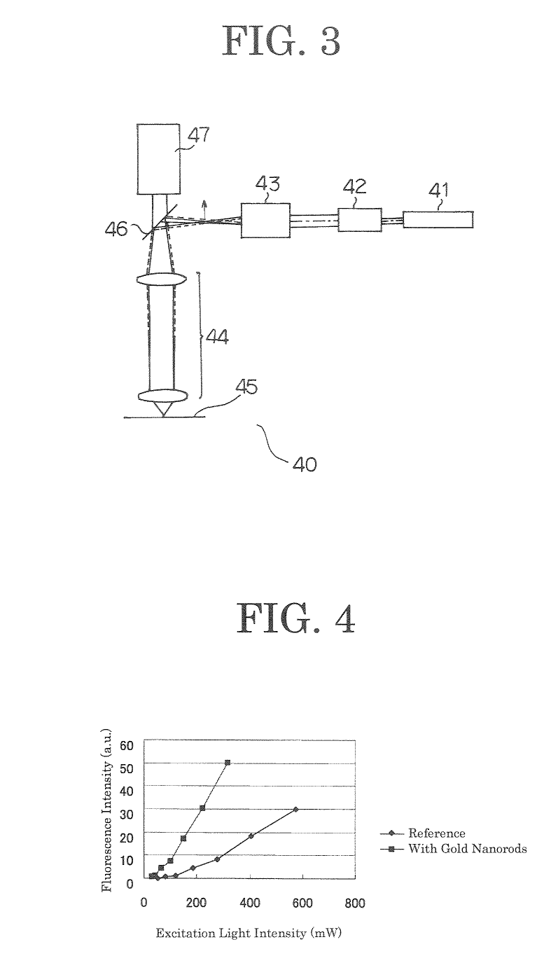

A schematic diagram of the basic composition of the two-photon excitation laser scanning microscope is shown in FIG. 3

The two-photon excitation laser scanning microscope 40 is equipped with a laser beam source 41 which emit a single-colored coherent pulsed light at a near-infrared wavelength region with sub-picosecond pulses, a beam conversion optical system 42 which changes a beam irradiated from a laser source to a desired measurement, a scanning optical system 43 in which a beam converted by the beam conversion optical system is focused on the imaging surface of the objective lens and scanned, an objective lens system 44 by which the above focused converted beam is projected on a sample surface 45, a dichroic mirror 46 and an optical detector 47.

A pulsed laser beam is focused on the sample surface 45 by means of the beam conversion optical system 42 and the objective lens system 44 through the dichroic mirror 46 to generate a fluorescence induced by two-photon absorption in the two-photon absorption fluorescence material inside the sample.

The sample surface 45 is then scanned with a laser beam; fluorescence intensities at each spot are detected by the optical detector 47 and a three-dimensional fluorescent image is obtained by plotting with a predefined computer based on the obtained location information.

As regard to the scanning mechanism, a laser beam may be scanned by using movable mirror such as galvanometer mirror or a sample on the stage which includes two-photon absorbent material may be moved, for example.

By the composition as described above, it is possible to obtain high resolution in an optic axis direction by using nonlinear effect of two-photon absorption itself.

In addition, higher resolution (both in in-plane and optic axis directions) can be obtained by using a confocal pinhole plate.

The fluorescent dye for two-photon fluorescence microscope is used by staining a sample or dispersing in a sample and can also be used for three-dimensional microimaging for biological cells, etc. as well as for industrial use and a compound with a cross section of high two-photon absorption is desired.

A technique related to two-photon fluorescence microscope using two-photon absorbent material known in the art is disclosed in JP-A No. 9-230246.

The scanning fluorescence microscope is characterized by being equipped with a laser irradiating optical system which emits a collimate beam enlarged to a desired measurement and a substrate on which multiple focus elements are formed; wherein the focus position of the focus elements are arranged corresponding to the image position of the objective lens system, and a beam splitter, which transmits long wavelength and reflects short wavelength, is positioned between the substrate on which focus elements are formed, and the objective lens system to generate fluorescence on the sample surface by multiphoton absorption.

By having such composition, it is possible to obtain high resolution in an optic axis direction by using nonlinear effect of the multiphoton absorption itself.

In addition, higher resolution (both in in-plane and optic axis directions) can be obtained by using cofocal pihole plate.

Such two-photon optic elements may be materials and thin films of the present invention, which have high two-photon absorption power, just the same as the above mentioned photoregulation elements, or solid substances dispersed in an optically-curable resin, etc.

The multi(two)photon absorbent material of the present invention is used as a two-photon absorption fluorescent material for the above multi(two)photon excitation laser scanning microscope.

The multi(two)photon absorbent material of the present invention exhibit high two-photon absorption property at a low density because it has large cross section of two-photon absorption compared to that of the existing two-photon absorption fluorescent material.

Because the material of the present invention is high in sensitivity, there is no need to increase the irradiated light intensity excessively and degradation and destruction of the material can be suppressed, leading to improvement of durability and further, harmful effects on the properties of other elements inside the materials can also be lowered.

Next, a multiphoton absorbent material of the present invention, gold nanorods will be explained.

The gold nanorods of the present invention is prepared by adding a surfactant to water and oil-based solvent to form a micelle, and after a step of reducing the gold nanorods by micelle, the gold nanorods having a core-shell structure is formed by acting a silane coupling agent in a uniformly dispersed state of the gold nanorods.

Specifically, metal fine particles which generate enhanced surface plasmon field, that is, four types of gold fine particles including 2 types of gold nanorods which differ from each other by presence or absence of SiO₂ coatings, and 2 types of spherical gold fine particles which also differ from each other by presence or absence of SiO₂ coatings are used as a way of physically sensitizing the two-photon absorbent material.

These fine particles can be obtained from particles, which have absorption region from visible to near-infrared region, in a reproducible fashion.

Furthermore, a stable fine particle-dispersed dye solution is obtained by reducing the fine particles in a micelle and adding a dye dissolved in an oil-based solvent mixed with water, as described later.

Technical ideas for each step will be explained.

The present invention is characterized by obtaining gold nanorods by reducing the gold nanorods in a micelle, which is formed by adding a surfactant in water and oil-based solvent, and by producing a core-shell structure by acting a silane coupling agent in a uniformly dispersed state of the gold nanorods after reduction.

The element which absorbed excitation light during photoreaction loses its energy in reaction by energy relaxation.

Of these elements, the deactivation process, in which energy obtained from light absorption is received by metals and become relaxed, of an element which exists near poles of electrically conductive materials such as metals becomes notable.

In order to lower the chances of having deactivation process, a silane coupling agent is used for forming SiO₂ film as an insulation layer in the present invention.

By using silane coupling agent in a uniformly dispersed state of the gold nanorods after reduction, it becomes possible to suppress the rapid production of secondary particles caused by the use of silane coupling agent and also, effect of narrowing the layer thickness distribution of every particles can be obtained with a gradual operation of silane coupling agent which gradually diffuses and penetrates through the oil-based solvent surrounding the gold nanorods.

Meanwhile, the uniformly dispersed state of the gold nanorods after reduction does not only imply the state immediately after the reduction, but it is apparent that the general state wherein the nanoparticles are separated, which is produced by a micelle structure for the purpose of using the present invention is also substantively the same.

When preparing a core-shell structure of the gold nanorods of the present invention, it is preferable to add water-insoluble dye, which is dissolved in an organic solvent, in a dispersion state to make a solution in which dye is only dispersed near the gold nanorods in a rod-like micelle.

Since this step takes place after preparing a core-shell structure of the gold nanorods, the gold nanorods are in the side of the oil-based solvent in the micelle structure and are coated with SiO₂ film.

When a water-insoluble dye, which is dissolved in an organic solvent, is added, it is dispersed by being taken up by the micelle structure and consequently, a structure in which the dye is dispersed only near the gold nanorods can be easily composed.

Meanwhile, the dye described here represents a substance which shows photoreaction to the enhanced plasmon field and does not only indicate coloring materials such as colorants or pigments.

Therefore, it also includes a substance which shows photoreactions such as polymerization initiators, according to the above definition.

Moreover, monomers and oligomers which polymerize by polymerization initiators can be also included at the same time.

Moreover, it is possible for the dye to be deposited on the surface of the nanorods for preparing a dye multilayer structure of the gold nanorods by evaporating the above oil-based solvent in the solution of core-shell structure of the gold nanorods.

The deposition mentioned here does not only indicate the deposition due to supersaturation of solvents.

In other words, it widely includes the condition in which materials inside the micelle change from liquid to solid state by evaporation of oil-based solvent surrounding the nanorods.

For that reason, a composition in which a dye is dispersed in resin membrane surrounding the nanorods by solvent evaporation is also included in the composition of the present invention even when binder resins, etc. are contained in the oil-based solvents.

Furthermore, it is preferable to further apply silane coupling agent on the surface of the dye multilayer structure of the above gold nanorods to produce a multilayer core-shell structure.

It is also possible to add an oil-based solvent to form a micelle structure again and act the silane coupling agent diluted with the oil-based solvent other than acting silane coupling agent diluted with a given solvent directly.

The gold nanorods having a core-shell structure which is produced as above may be applicable as a multiphoton absorption reactant or reaction auxiliary agent.

By using dye material containing metal fine particles which generate enhanced surface plasmon field or fine particles at least partially coated with a metal and multiphoton absorbent material of the present invention, the multiphoton absorbent material, which exists in the enhanced surface plasmon field generated by irradiation of light, can obtain an irradiation effect more intense than that of the irradiated light.

For example, it is possible to significantly sensitize the photoexcited reaction of the two-photon absorbent material which exists in the enhanced surface plasmon field without changing the intensity of irradiated light because the two-photon absorption reaction, which is one of the multiphoton absorption processes, occurs by absorbing light corresponding to a square of the light intensity.

Moreover, it is possible to decrease and avoid the loss caused by the dispersion of excitation light by making metal fine particles, which generate enhanced surface plasmon field, into ultra fine particles of nano-meter order.

Furthermore, an effective sensitization is possible by using fine particles, which are coated with insulating layers of the present invention and generate enhanced surface plasmon field, and physically preventing deactivation process, in which photoexcited carriers in the multiphoton absorbent material, which exist in enhanced surface plasmon field, are energy transferred toward the surface of fine particles, to provide photoexcited carriers in the reaction effectively.

And it is possible to increase the enhancement of the enhanced surface plasmon field which generate on the surface of fine particles by applying fine particles having anisotropy, and to control the absorption wavelength (resonance wavelength) by adjusting aspect ratio of particles. Consequently, more sensitization became possible by the designs conforming to the wavelength sensitivity characteristics of the multiphoton absorbent material.

Furthermore, by applying gold nanorods as fine particles having anisotropy, fine particles of 20 nm or less diameter with a uniform aspect ratio can be obtained with appropriate reproducibility and effective sensitization with small dispersion loss is possible.

And by applying gold nanorods, it is possible to easily cover from visible light region to near-infrared region by changes in aspect ratio, and effective sensitization corresponding to the wide range of absorption wavelength of multiphoton dyes is also possible.

By the present invention, it is possible to provide a multiphoton absorbent material with high sensitivity which has physical mechanism of sensitization induced by enhanced surface plasmon field, and is usable as a multiphoton absorption reaction material with high sensitivity previously unheard of. And the reaction can be initiated by the multiphoton absorption reaction process with high sensitivity without using expensive, high-powered pulsed laser, and inexpensive, fine processed products of under diffraction limit or three-dimensional modeled products, using the characteristic of multiphoton absorption, can be produced.

Moreover, by using the multiphoton absorption reaction material as a reaction auxiliary agent as well as for the reaction directly, it is possible to excite various reactions by the multiphoton processes.

By the manufacturing method of the gold nanorods of the present invention, gold nanorods, with which formation of the secondary particles is unlikely, are easily dispersible and capable of inducing photoreaction effectively due to small layer thickness distribution of SiO₂ films formed on the surface of nanorods and easily controllable film-forming speed, can be obtained.

Furthermore, by adding water-insoluble dye dissolved in an organic solvent to the dispersion state during manufacturing process of the gold nanorods to make a solution in which the dye is dispersed only near the gold nanorods in the micelle, dye is distributed only around the enhanced plasmon field and excited effectively. At the same time, the dye outside the enhanced field is relatively small in amount and deactivation process such as concentration quenching by the exchanges of energy between dyes in the solution is suppressed, thereby providing more effective photoreaction course.

And by evaporating oil-based solvent in the solution of dispersion state, it is possible to form a nanorod-dye multilayer structure in which dye is deposited on the surface of the nanorods and a solid phase including dye layers surrounding the nanorods, making it easier for the transfer from growth solution of the nanorods to different dispersion state to take place and the dispersion condition such as density and dispersion solvent of the particles to be controlled.

Moreover, by making the nanorod-dye multilayer structure of the present invention into a multilayer core-shell structure of which the surface is coated with a silane coupling agent, it is unlikely to be affected by remelting, etc. of the materials composing the core-shell structure such as dye and resin, etc. in the dispersion medium, making it easier to control the dispersion condition of density and dispersion solvent of the particles in a wide sphere.

### EXAMPLE

Herein below, with referring to Examples and Comparative Examples, the invention is explained in detail and the following Examples and Comparative Examples should not be construed as limiting the scope of this invention.

### Example 1

In the following steps, gold nanorods were prepared using photoreduction method and the surfaces of the gold nanorods were further coated with SiO₂ films using a silane coupling agent.

First, 70 ml of CTAB (cetyltrimethylammonium bromide) solution of 0.18 mol/l, 0.36 ml of cyclohexane, 1 ml of acetone and 1.3 ml of silver nitrate solution of 0.1 mol/l were mixed by means of a magnet stirrer to prepare a raw material solution.

Furthermore, after 2 ml of chlorauric acid solution of 0.24 mol/l was added, 0.3 ml of ascorbic acid solution of 0.1 mol/l was added and disappearance of color of the chlorauric acid solution was confirmed.

The mixed solution was then transferred to a Petri dish of 100 mm diameter and an ultraviolet light at 254 nm was irradiated using a low-pressure mercury vapor lamp (SUV-16 manufactured by As One Corp.).

After 20 minutes of irradiation, a gold nanorod dispersion liquid at a center absorption wavelength of 830 nm was obtained.

1 ml of 5 vol % ethanol solution of (3-aminopropyl) ethyldiethoxysilane was added to the above gold nanorod dispersion liquid and it was heated at 80° C. for 2 hours to form a thin film of SiO₂ on the surface of the gold nanorods.

The gold nanorods with SiO₂ thin films were obtained by above steps.

Further, 0.5 ml of acetone saturated solution of two-photon absorption fluorescent dye expressed by the following Formula (1) was injection mixed in 2 ml of gold nanorods solution on which the above SiO₂ film was formed to obtain a mixed solution of the gold nanorods with SiO₂ thin film and the dye.

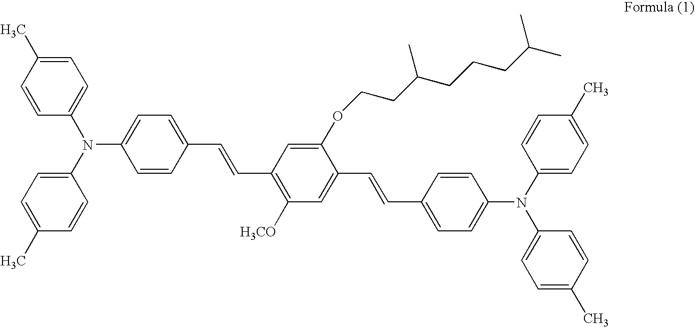

### Example 2

A gold nanorod dispersion liquid was obtained by using a method as similar to the above Example 1.

2 ml of the gold nanorod dispersion liquid was divided without going through the forming step of SiO₂ thin film and 0.5 ml of acetone saturated solution of two-photon absorption fluorescent dye expressed by the above Formula (1), as similar to the Example 1 was added and mixed to obtain a mixed solution of the gold nanorods without SiO₂ thin film and the dye.

### Example 3

In the following steps, spherical gold fine particles were prepared using a photoreduction method and the surfaces of the spherical gold fine particles were further coated with SiO₂ films using a silane coupling agent.

First, 70 ml of CTAB (cetyltrimethylammonium bromide) solution of 0.18 mol/l, 0.36 ml of cyclohexane and 1 ml of acetone were mixed by means of a magnet stirrer to prepare a raw material solution. The silver nitrate solution was not added because spherical particles were being prepared unlike in the case of Examples 1 and 2.

Further, after 1 ml of chlorauric acid solution of 0.24 mol/l was added, 0.15 ml of ascorbic acid solution of 0.1 mol/l was added and disappearance of color of the chlorauric acid solution was confirmed.

The mixed solution was then transferred to a Petri dish of 100 mm diameter and an ultraviolet light at 254 nm was irradiated using a low-pressure mercury vapor lamp (SUV-16 manufactured by As One Corp.).

After 20 minutes of irradiation, a dispersion liquid at a center absorption wavelength of 530 nm in which spherical gold fine particles were dispersed in a micelle was obtained.

1 ml of 5 vol % ethanol solution of (3-aminopropyl) ethyldiethoxysilane was added to the above gold nanorod dispersion liquid and it was heated at 80° C. for 2 hours to form a thin film of SiO₂ on the surface of the spherical gold fine particles.

Spherical gold fine particles with SiO₂ thin films were obtained through the above steps.

Furthermore, 0.5 ml of two-photon absorption fluorescent dye expressed by the following Formula (2), dimethyl sulphoxid (DMSO) solution of 3 mmol/was injection mixed in 2 ml of the above-obtained spherical gold fine particle solution with SiO₂ thin films to obtain a mixed solution of the spherical gold fine particles with SiO₂ thin film and the dye.

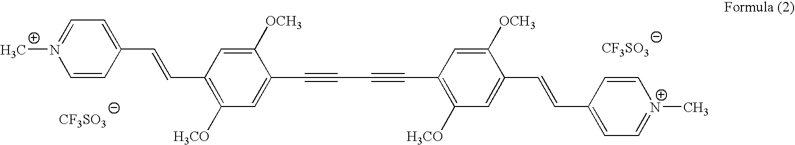

### Example 4

A dispersion liquid of spherical gold fine particles was prepared by a method similar to the above Example 3.

2 ml of the gold nanorod dispersion liquid was divided without going through the forming step of SiO₂ thin films and 0.5 ml of two-photon absorption fluorescent dye expressed by the above Formula (2), as similar to the Example 3 was added and mixed to obtain a mixed solution of the spherical gold fine particles without SiO₂ thin film and the dye.

### Comparative Examples 1 to 4

0.5 ml each of two-photon absorption fluorescent dye solutions expressed by above Formulas (1) and (2) were added to each of 2 ml of a starting material solution of nanorod, that is a mixed solution of 70 ml of CTAB (cetyltrimethylammonium bromide) solution of 0.18 mol/l, 0.36 ml of cyclohexane and 1 ml of acetone and stirred to obtain two types of solution.

As similar to the above Examples 1 and 2, the solution mixed with the dye expressed by the above Formula (1) was defined as Comparative Example 1 and the solution mixed with the dye expressed by the above Formula (2) was defined as Comparative Example 2.

In these solutions, each two-photon absorption fluorescent dye is being localized and dispersed in a oil-based solvent in a micelle.

The two types of dye are insoluble in water.

[Correlation Measurement 1 between Excitation Light Intensity and Two-Photon Fluorescence Intensity]

The two-photon excitation fluorescence was measured by binding each focusing point in the mixed solutions of Example 1 and Comparative Example 1 using an infrared femtosecond laser, MaiTai manufactured by Spectraphysics, Inc.

The correlation between excitation light intensity and two-photon fluorescence intensity is shown in FIG. 4.

Meanwhile, it is focused to the point approximately 8 mm inside of the optical cell.

A square effect where the fluorescence intensity is doubled when the excitation light intensity is doubled was observed in each solution and they were confirmed to be two-photon absorption fluorescences.

As a result of measurements, approximately 8 times as much of the fluorescence intensity was observed in a dye solution containing the gold nanorods of Example 1 relative to the Comparative Example 2 which does not contain the gold nanorods, confirming the enhancing effect of the gold nanorods with SiO₂ thin films on the two-photon fluorescence of the bulk solution.

[Correlation Measurement 2 Between Excitation Light Intensity and Two-Photon Fluorescence Intensity]

A comparative measurement with the above Comparative Example 1 was conducted for the mixed solution of the gold nanorods without SiO₂ thin film and the dye of Example 2 by using a method as similar to the above measurement.

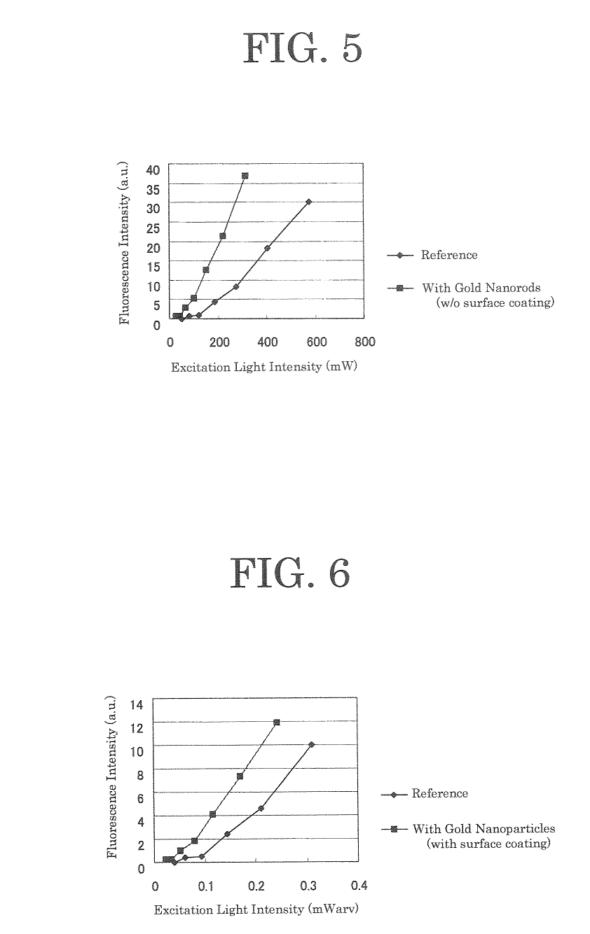

The measurement result is shown in FIG. 5.

The square effect where the fluorescence intensity is doubled when the excitation light intensity is doubled was also observed in the solution prepared in Example 2 and it was confirmed to be two-photon absorption fluorescence. Approximately four times as much of the fluorescence intensity was observed relative to the Comparative Example 1, thereby confirming the enhancing effect of the gold nanorods without SiO₂ thin film on the two-photon fluorescence of the bulk solution.

[Correlation Measurement 3 between Excitation Light Intensity and Two-photon Fluorescence Intensity]

The measurement was conducted by using a femtosecond pulse with a wavelength of 560 nm, pulse width of 100 fs and repeated frequency of 1 kHz, generated from an optical parametric amplifier (OPA-800 manufactured by Spectraphysics, Inc.).

The pumping light of the optical parametric amplifier of a femtosecond laser, Tsunami manufactured by Spectraphysics, Inc. and the power output of Spitfire amplifier manufactured by Spectraphysics, Inc., which is activated by a Nd:YLF laser Evolution manufactured by Spectraphysics, Inc was used.

The position of the optical cell was set as similar to the above measurements 1 and 2.

The measurement results of the above Example 3 and Comparative Example 2 are shown in FIG. 6.

The square effect where the fluorescence intensity is doubled when the excitation light intensity is doubled was also observed in each solution and they were confirmed to be two-photon absorption fluorescences.

Approximately two times as much of the fluorescence intensity was observed in the dye solution containing the spherical gold fine particles of Example 3 relative to the Comparative Example 2 which does not contain spherical gold fine particles, thereby confirming the enhancing effect of the spherical gold fine particles with SiO₂ thin film on the two-photon fluorescence of the bulk solution.

[Correlation Measurement 4 Between Excitation Light Intensity and Two-photon Fluorescence Intensity]

A comparative measurement with the Comparative Example 2 was conducted for the mixed solution of the spherical gold fine particles without SiO₂ thin film and the dye of Example 4 in a similar way.

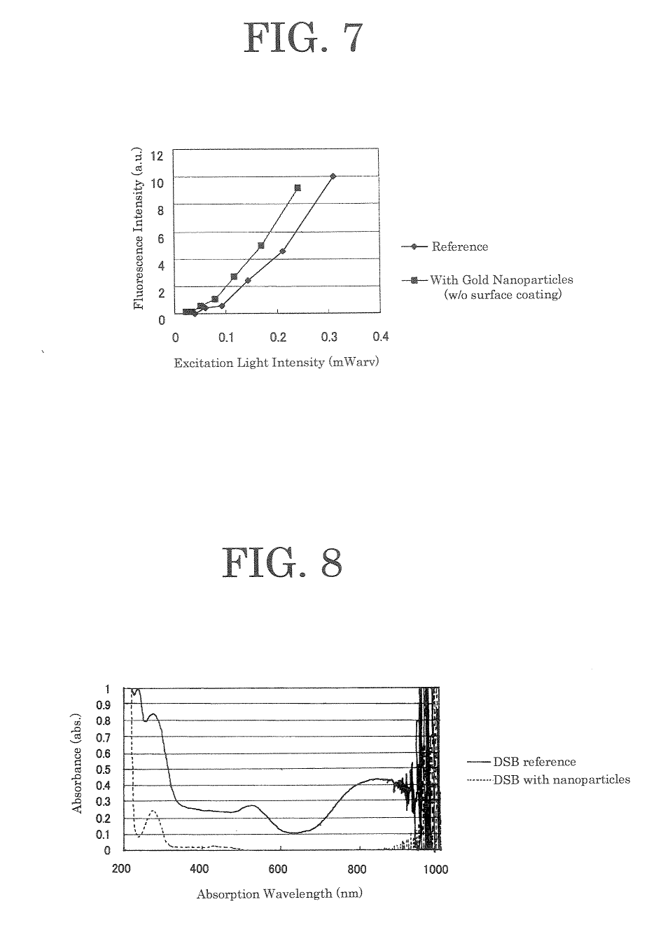

The measurement result is shown in FIG. 7.

The square effect where the fluorescence intensity is doubled when the excitation light intensity is doubled was also observed in the solution prepared in Example 4 and it was confirmed to be two-photon absorption fluorescence.

Approximately 1.5 times as much of the fluorescence intensity was observed relative to the Comparative Example 2, thereby confirming the enhancing effect of the spherical gold fine particles without SiO₂ thin film on the two-photon fluorescence of bulk solutions.

[Observation of Absorption Spectrum]

The absorption spectrum of each solution of the above Example 1 and Comparative Example 1 was measured. The measurement results are shown in FIG. 8.

In the dye solution containing the gold nanorods of Example 1 as shown in FIG. 8, in addition to absorption by the dye, the absorption by the gold nanorods can be observed near 800 nm and it is assumed that the irradiation light of the two-photon excitation light source at 780 nm wavelength was absorbed and enhanced effectively and resulted in two-photon absorption reaction.

The above Examples are partial examples of the embodiments of the present invention and it is possible to have other material compositions. The Examples should not be construed as limiting the other compositions based on the idea of the present invention.

By the present invention, it is possible to obtain dye material using multiphoton absorbent material which can be used as a bulk of unprecedentedly high sensitivity, dye solution, gold nanorods making up the multiphoton absorbent material, which are applicable for three-dimensional multilayer optical memories, three-dimensional optical recording media, materials for two-photon optical modeling and two-photon fluorescence microscopes.

What is claimed is:

1. A dye material, comprising:
fine particles and a multiphoton absorbent material,
wherein the fine particles are fine metal particles that generate enhanced surface plasmon field or fine particles partially coated with a metal that generates enhanced surface plasmon field.

2. The dye material according to claim 1, wherein the dye material is used as a multiphoton absorption reaction auxiliary agent.

3. The dye material according to claim 1, wherein the outermost surface of the fine particles is coated with an insulation layer.

4. The dye material according to claim 3, wherein the dye material is used as a multiphoton absorption reaction auxiliary agent.

5. The dye material according to claim 1, wherein the fine particles have anisotropy.

6. The dye material according to claim 5, wherein the dye material is used as a multiphoton absorption reaction auxiliary agent.

7. The dye material according to claim 5, wherein the outermost surface of the fine particles that have anisotropy is coated with an insulation layer.

8. The dye material according to claim 7, wherein the dye material is used as a multiphoton absorption reaction auxiliary agent.

9. The dye material according to claim 5, wherein the fine particles that have anisotropy are gold nanorods.

10. The dye material according to claim 9, wherein the dye material is used as a multiphoton absorption reaction auxiliary agent.

11. The dye material according to claim 9, wherein the outermost surface of the gold nanorods is coated with an insulation layer.

12. The dye material according to claim 11, wherein the dye material is used as a multiphoton absorption reaction auxiliary agent.

13. A dye material, comprising:
fine particles and a multiphoton absorbent material,
wherein the fine particles are fine metal particles that have a core-shell structure and generate enhanced surface plasmon field or fine particles that have a core-shell structure and are partially coated with a metal that generates enhanced surface plasmon field.

14. The dye material according to claim 13, wherein the outermost surface of the fine particles is coated with an insulation layer.

15. The dye material according to claim 13, wherein the fine particles have anisotropy.

16. The dye material according to claim 15, wherein the outermost surface of the fine particles is coated with an insulation layer.

17. The dye material according to claim 1, wherein the fine particles that have anisotropy are gold nanorods.

18. The dye material according to claim 17, wherein the outermost surface of the gold nanorods is coated with an insulation layer.

19. The dye material according to claim 18, wherein the dye material is used as a multiphoton absorption reaction auxiliary agent.
